(19) United States
(12) Patent Application Publication
(10) Pub. No.: US 2018/0036833 A1
(43) Pub. Date: Feb. 8, 2018

(54) FASTENING ELEMENT

(71) Applicant: EJOT GmbH & Co. KG, Bad Berleburg (DE)

(72) Inventor: Dieter MAUER, Lollar (DE)

(21) Appl. No.: 15/551,416

(22) PCT Filed: Feb. 3, 2016
(86) PCT No.: PCT/EP2016/052292

§ 371 Date: Aug. 16, 2017

(30) Foreign Application Priority Data
Feb. 16, 2015 (DE) 10 2015 202 776.7

(51) Int. Cl. B23K 20/12; F16B 37/06

(52) U.S. Cl. CPC B23K 20/127; B23K 20/1295; F16B 37/061; B23K 35/0288

(57) ABSTRACT

The invention relates to a fastening element (10) for connecting to a component (12), wherein the fastening element (10) comprises a flange with drive structures, wherein a connection region is formed on the flange, through the fusing of which the fastening element (10) can be fastened to the component (12) by friction welding, wherein the fastening element (10) comprise a shaft which is arranged on the side of the flange opposite the connection region. The fastening element (10) further comprises a guide region between shaft and connection region in the axial direction, which comprises a guide surface, which comprises at least one segment of an outer surface, which is associated with a cone which broadens in the direction of the connection region. The invention is characterized in that the guide region has a flat surface on the end thereof facing towards the shaft, wherein the extension of the flat surface in a radial direction is greater than the diameter of the shaft.

The invention relates to a fastening element with a shaft, of the type specified in the preamble, of claim 1, and to a tool for setting a fastening element of this kind, of the type specified in the preamble of claim 1.

DE 20 2004 014 071 U1 relates to a generic fastening element which comprises a flange with a connection region for attachment to a component. On the side of the flange which faces away from the connection region, the fastening element further comprises a shaft. For connecting the fastening element to a component, an axial force is applied on the flange surface by a drive tool having a tubular pressure piece which is slid over the shaft area. A recess is used to fix the fastening element in the direction of rotation so as to enable the fastening element to be welded to the component by rotation of the drive tool.

The pressure piece ensures shock-free rotation of the bolt which will thus rotate smoothly about its rotational axis which lies on the shaft axis.

The disadvantage of this arrangement is that it requires the inner diameter of the pressure piece to be adapted very precisely to the shaft diameter to ensure the intended function. In this arrangement, an insertion aid in the form of a conical taper facilitates the mounting of the precisely fitting workpiece. Consequently, a matching tool is required for every shaft diameter. Moreover, this arrangement is subject to wear because only slight material erosion can be tolerated in view of the requirement for high fitting accuracy.

It is an object of the invention to overcome the abovementioned disadvantages.

This object is accomplished by the characterizing features of claim 1 in combination with the features of its preamble.

An advantageous embodiment of the invention is specified in the dependent claims.

In a known manner, a fastening element for connecting to a component comprises a flange with drive structures, with a connection region being integrally formed on said flange, through the fusing of which the fastening element can be fastened to the component by friction welding. The fastening element further comprises a shaft which is arranged on the side of the flange opposite the connection region. The fastening element further comprises a guide region between the shaft and the connection region in the axial direction, which guide region comprises a guide surface that comprises at least a segment of an outer surface which segment is associated with a cone which broadens in the direction of the connection region.

The invention is characterized in that the guide region has an axial pressure surface on the end thereof which faces the shaft, wherein the extension of the axial pressure surface in a radial direction is greater than the diameter of the shaft. Since the axial pressure forces required for the fitting can be transmitted via the end face which is in particular planar and orthogonal to the shaft axis, the guide region merely has to perform a centering function. This considerably minimizes tool wear. Furthermore, any uneven rotary movement is thus avoided.

More specifically, the axial pressure surface is in the form of an annular surface which is offset from the flange or the shaft. A pressure piece having an annular surface and a conical recess for transferring the contact pressure and for providing centered guidance during operation can engage this annular surface which transitions into the lateral guide surface. As a result, most of the area within the annular surface can largely be designed freely, irrespective of any centering functions.

A drive tool may for example be provided for driving such a fastening element, which drive tool comprises a pressure piece having an annular surface whose recess is larger than the shaft diameter and whose outer dimensions roughly correspond to the extension of the end face. In addition, the pressure piece may be designed such that the annular surface forms the upper face of a frustum which conically widens in the fastening direction. Such, an outer surface will thus form a contact area with the guide surfaces of the guide region, with the annular surface at the same time pressing on the axial pressure surface.

This allows the rotating fastening element to be held securely centered during the fastening process, The presence of the lateral conical guide of the fastening element in the guide region thus allows the shaft to be designed regardless of any centering requirements. This makes it possible to use only a single drive tool for processing fastening elements of different shaft diameters which are smaller than the diameter of the recess. A uniform guide region can be provided to meet this need.

An arrangement of the guide region between the shaft and the flange is thus achieved in a particularly advantageous manner. This also allows the flange with its drive means to be designed irrespective of any centering requirements. In such an arrangement, the guide region extends radially within the drive means. This ensures smoother guiding. Moreover, this design is particularly well suited for production by cold forming.

In the abovementioned embodiment, the guide region can be offset from the flange. This allows the pressure region and the guide region and drive region to be separated from one another.

In yet another embodiment, the flange may comprise the guide region. This means that in the direction of the connection region, the guide region transitions smoothly and without any offset into the flange with the drive structures.

In a preferred embodiment, the guide surface takes the form of a completely circumferential outer surface of the associated cone, This is a particularly rotationally symmetrical design which thus avoids imbalances around the shaft axis.

Preferably, the cone of the guide region can form an angle of between 35° and 65° with the axis of the fastening element. This angle range allows a particularly good centering effect to be achieved during rotation.

The extension of the pressure surface, which is in particular of annular shape, is chosen such that the contact pressures required for setting the fastening element can be transferred from the pressure piece of the drive tool to the fastening element via this pressure surface.

The extension of the pressure surface is essentially dependent on the material of the component and on the material of the fastening element.

Dimensions sufficient for transmitting the contact, pressure may be present if the extension of the end face facing the shaft is larger by at least 10% than the diameter of the shaft. This allows a sufficient pressure surface to be provided for the fastening element. For a common shaft diameter of 6 mm, an end face diameter of at least 7 mm is reasonable, for example.

Another preferred embodiment is obtained if the outer diameter of the end face is 7 mm and the outer diameter of the shaft is 6 mm or 5 mm or 4 mm. The specific design of the guide region and the flange thus makes it possible to use a single drive tool design for reliably attaching a multitude of different standard shaft diameters, without having to change the drive tool.

More specifically, the shaft is of the threaded type, with the shaft diameter corresponding to the outer diameter of the thread.

The end face is preferably normal to the shaft axis and thus has a particularly rotationally symmetrical design which very much improves centering during the setting process.

The fastening element may preferably comprise a connection region having an end which is designed such that it fixes a contact area.

In a particularly advantageous embodiment, the fastening element may be designed such that the contact area determined by the connection region is plane-parallel to the end face, preferably both are orthogonal to the shaft axis. The plane-parallel orientation of the contact area and the end face makes it possible to ensure particularly smooth running of the fastening element during rotation.

The invention furthermore relates to a fastening system comprising a fastening element for connection to a component, wherein the fastening, element comprises a flange with drive structures, with a connection region being integrally formed on the flange through the fusing of which the fastening element can be fastened to the component by friction welding, wherein the fastening element has a shaft which is arranged on the side of the flange opposite the connection region. The fastening element further comprises a guide region between the shaft and the connection region in, the axial direction, which guide region comprises a guide surface which comprises at least one segment of an outer surface that is associated with a cone which broadens in the direction of the connection region.

The fastening system further comprises a tool for attaching a fastening element of the abovementioned type, said tool having a drive recess for transmitting a rotary movement, and comprises a pressure piece which is partially hollow and which has a frustum-shaped recess on its end which faces the fastening element, said recess constituting a tool-side guide surface.

According to the invention, the pressure piece and the axial pressure surface are adapted to one another so as to reliably transmit the pressure force required for the setting process, and the guide surface on the tool side and the guide region on the fastening element side are adapted to one another so as to enable the pressure piece and the flat pressure surface to abut on one another and the guide region and the guide surface to be brought into contact with each other by an eccentric position of the inserted fastening element.

More specifically, the guide surfaces of the tool and the guide surfaces of the fastening element have the same angle. When the axial pressure surfaces of the tool and of the centrally inserted fastening element contact each other, the guide surfaces will be parallel and slightly spaced from one another. Said minor spacing can preferably be between 10 μm and 1 mm.

The fastening element may preferably be of the above mentioned design.

Additional advantages, features and possible applications of the present invention may be gathered from the description which follows, in connection with the embodiments illustrated in the drawings.

Throughout the description, claims and drawings, those terms and associated reference signs are, used as are listed in the List of Reference Signs below. In the drawings,

FIG. 1 is a view of a friction element which can be connected to a component via a rotary movement and the application of an axial force;

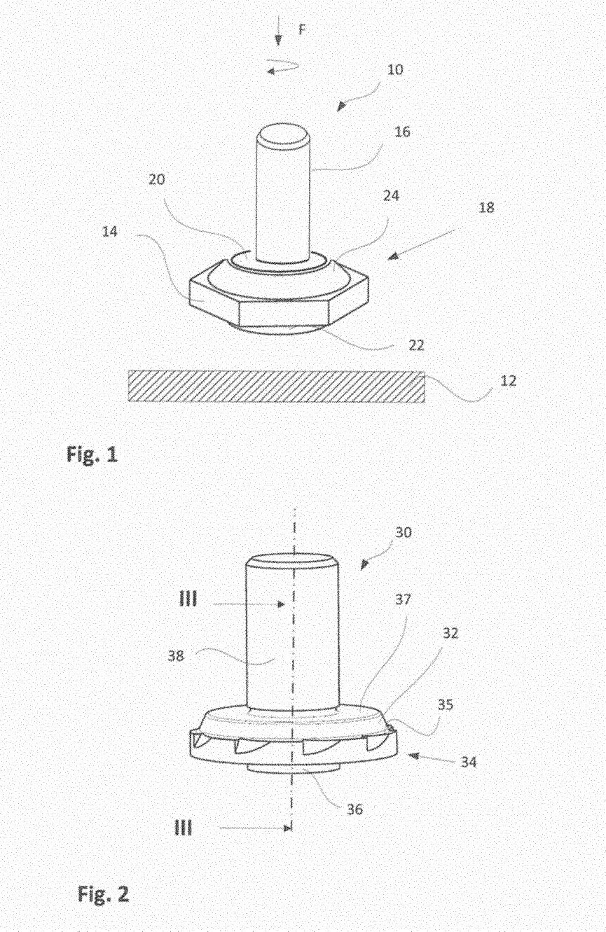

FIG. 2 is a view of another embodiment of a friction element according to the invention;

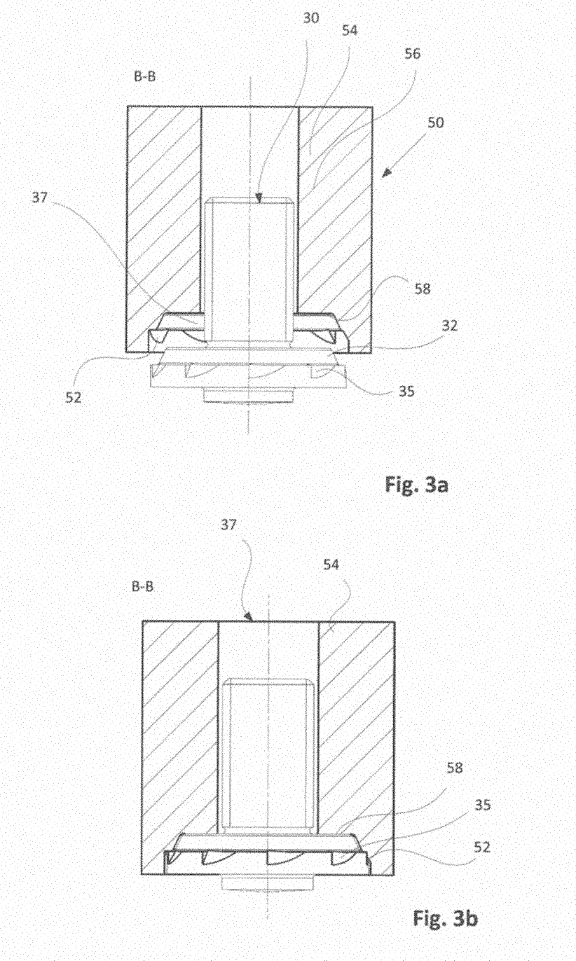

FIG. 3a is a cross-sectional view of a fastening element of FIG. 1;

FIG. 3b is a view of the fastening element completely received in the drive tool;

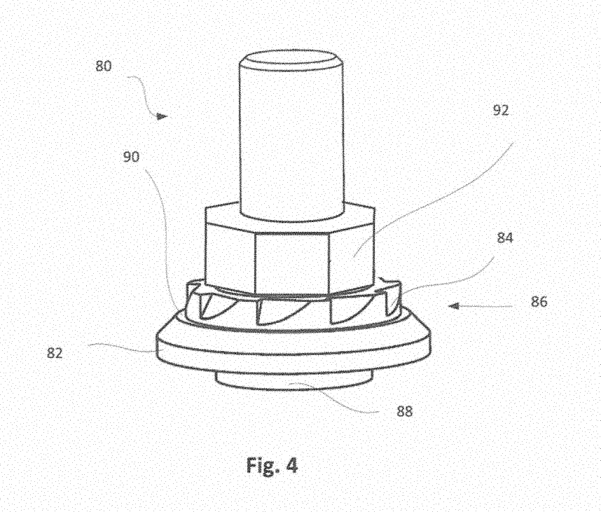

FIG. 4 is a view of an embodiment in which a drive tool is provided which comprises a pressure piece that is provided radially outside the drive means;

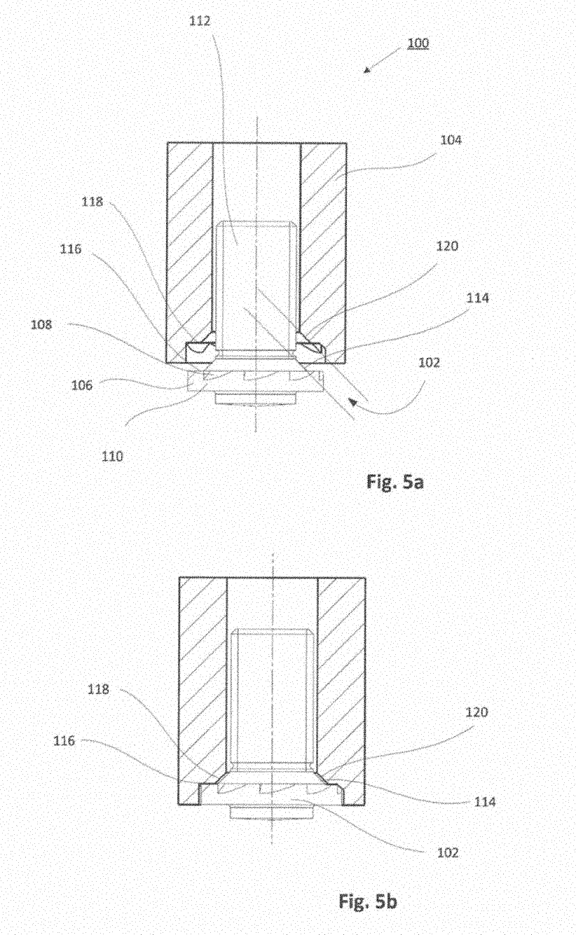

FIG. 5a is a cross-sectional view of a fastening system before a fastening element is completely received in a tool, and

FIG. 5b is a cross-sectional view of a fastening system after a fastening element has been completely received in a tool.

FIG. 1 is a view of a fastening element 10 according to the invention which can be connected to a component 12 by means of a rotary movement and the application of an axial force F. The fastening element 10 comprises a flange 14 with drive means thereon for transmitting a rotary movement from a tool to the fastening element 10, The drive means are provided in the form of an external hexagon drive. In the direction of the shaft 16, a guide region 18 follows after the flange 14. The guide region 18 is frustum-shaped and offset from the flange 14. On its end facing the shaft, the frustum has a flat surface 20 which constitutes an annular surface. The contact pressure required for the friction welding connection is, transmitted from the flat surface 20 to the fastening element 10. A frictional connection can thus be achieved between the fastening element 10 and the component 12 through the fusing of a connection region 22. The conical guide surface 24 acts to center the fastening element 10 on associated guide surfaces of a drive tool (not shown) during the fastening process. This ensures uniform rotation of the fastening element 10 about its axis and ensures shock-free running of the fastening element 10 during the friction welding process.

The way the fastening element 10 cooperates with the tool will now be described with reference to the next Figures.

FIG. 2 is a view of another embodiment of a fastening element 30 according to the invention. In this embodiment, the connection region 32 fleshly transitions into the flange 24. On the one side of the flange 34. the fastening element has a connection region 36 and, on the side opposite the connection region, a shaft 38. The drive means are provided in the form of toothing 35. A cross-sectional view of this embodiment of the fastening element 30 will now be described in more detail with reference to FIGS. 3a and 3b. The required contact pressure forces are transmitted via the flat annular axial pressure surface 37.

FIG. 3a is a cross-sectional view of a fastening element 30 of FIG. 1. The fastening element 30 has drive means 35 which are formed in the flange 34 as recesses. Respective associated drive means 52 for transmitting the rotary movement are integrally formed on the drive tool 50. The drive tool 50 also has a pressure piece 54.

The pressure piece 54 is used to transmit the contact pressure to the fastening element 30. For this purpose, the fastening element 30 has an annular axial pressure surface 56 which transitions into a conical guide surface 58. In the feeding operation, the fastening element 30 is first clasped by the drive means 35 and then its guide region 32 is inserted into a matching recess in the pressure piece 54. The annular axial pressure surface 56 thus presses down on the axial pressure surface 37, which is formed as an annular surface around the shaft, in the fastening direction. During rotation, the fastening element 30 is centered via the guide surfaces 34 and the corresponding conical guide surface 58 of the drive tool 50. This ensures smooth running of the fastening element 30 without any wear due to the high contact pressures since no contact pressure is exerted on the conical guide surface 58 of the drive tool 50.

The fastening element 30 is thus first guided by the drive portion of the drive tool 50 and its axial pressure surface 37 is then made to contact the annular axial pressure surface 56 of the pressure piece 54.

FIG. 3b is a view of the fastening element completely accommodated within the drive tool 50. Once the axial pressure surfaces 37 of the fastening element abut on the axial pressure surface 56 of the pressure piece 54, the drive means 52 will be spaced from the drive means 35 of the fastening element. This will prevent jamming of the fastening element 30 with the drive means 52 as the fastening element 30 is balanced and/or centered by the pressure piece 54. The corresponding guide surfaces 34, 58 have so much play that there will be no axial forces acting on the guide surface 34 of the fastening element 30 if it is in an ideal centric and straight position.

The corresponding axial pressure surfaces 37 of the fastening element 30 and the axial pressure surface 56 of the drive tool 50 reliably transmit the axial force F required for the frictional welding process, with the guide surface 58 of the drive tool 50 together with the corresponding guide surface 34 ensuring a stable position during insertion.

FIG. 4 is a view of an embodiment in which the axial pressure surface 90 is provided radially outwardly of the drive means 84. The fastening element 80 has a guide region 82 which is arranged between the flange 86 with the drive means 84 and the connection region 88.

This design allows the entire area which is radially inwardly of the annular axial pressure surface 90 of the centering element 82 to be designed freely without having to ensure the stabilization of the element. Consequently, in particular with such a design, premounted elements, e.g. a fastening element 80 in the present case, can be mounted on a component with a nut 92, which still allows a stable attachment ensuring smooth running.

FIG. 5a is a view of a fastening system 100 comprising a fastening element 102 as well as a tool 104 for attaching a fastening element 102. As already described before, the fastening element comprises a flange 106 having drive structures 108. A connection area 110 is integrally formed on the flange 106 through the fusing of which the fastening element 102 can be connected to its surface. Between its shaft 112 and its connection area 110, the fastening element 102 has a guide region with a guide surface 114. The fastening element 102 further comprises an axial pressure surface 116. This axial pressure surface 116 cooperates with an axial pressure surface 118 of the tool 104 so as to transmit the contact pressure from the tool to the fastening element 102. The guide surface 114 of the fastening element 102 is arranged so as to be parallel to the guide surface 120 of the tool. The guide surface 120 of the tool is designed as a conical recess and thus adapted to correspond to the conical guide surface 114 of the fastening element 102.

As may be seen in FIG. 5b, which is a cross-sectional view of the fastening element 102 fully inserted, the pressure force is transmitted via the axial pressure surfaces 116, 118 which come to lie on one another, with a small distance remaining between the guide surfaces 120, 114 which distance will not affect the transmission of the axial pressure but will act to keep any tipping of the fastening element 102 from its rotational axis within narrow limits. Particularly secure and high-quality fastening is thus achieved.

1. Fastening element for connecting to a component, which fastening element comprises a flange with drive structures, wherein a connecting region is integrally formed on the flange, through the fusing of which the fastening element can be fastened to the component by friction welding, wherein the fastening element comprises a shaft which is arranged on the side of the flange opposite the connection region; the fastening element further comprises a guide region between the shaft and the connection region in the axial direction, which connection region comprises a guide surface, which comprises at least one segment of an outer surface, which is associated with a cone which broadens in the direction of the connection region characterized in that the guide region has an axial pressure surface on its end facing the shaft, wherein the extension of the axial pressure surface in a radial direction is greater than the diameter of the shaft.

2. Fastening element according to claim 1 characterized in that the guide region is arranged between the shaft and the flange.

3. Fastening element according to claim 1 characterized in that the flange comprises the guide region.

4. Fastening element according to claim 1 characterized in that the guide region is arranged between the connection region and the flange.

5. Fastening element according to claim 1 characterized in that the guide surface comprises a completely circumferential outer surface of the associated cone.

6. Fastening element according to claim 1 characterized in that the cone forms an angle of more than 35°, in particular of between 35° and 65°, with the axis of the fastening element.

7. Fastening element according to claim 1 characterized in that the flat pressure surface is normal to the shaft axis.

8. Fastening element according to claim 1 characterized in that the connection region is designed such that it defines a contact surface.

9. Fastening element according to claim 8 characterized in that the contact surface is plane-parallel to the axial pressure surface.

10. Tool for fastening a fastening element according to claim 1, wherein said tool comprises a drive recess for transmitting a rotary movement and a pressure piece which is partially hollow and which has a frustum-shaped recess on its end facing the fastening element which recess forms a guide surface on the tool side.

11. Tool according to claim 10 characterized in that said pressure piece has an annular axial pressure surface in the inner area of the frustum-shaped recess.

12. Fastening system comprising a fastening element for connecting to a component, which fastening element comprises a flange with drive structures, wherein a connecting region is integrally formed on the flange, through the fusing of which the fastening element can be fastened to the component by friction welding, wherein the fastening element comprises a shaft which is arranged on the side of the flange opposite the connection region; the fastening element further comprises a guide region between the shaft and the connection region in the axial direction, which connection region comprises a guide surface, which comprises at least one segment of an outer surface, which is associated with a cone which broadens in the direction of the connection region characterized in that the guide region has an axial pressure surface on its end facing the shaft, wherein the extension of the axial pressure surface in a radial direction is greater than the diameter of the shaft and
a tool that comprises a drive recess for transmitting a rotary movement and a pressure piece which is partially hollow and which has a frustum-shaped recess on its end facing the fastening element which recess forms a guide surface on the tool side, characterized in that said pressure piece has an annular axial pressure surface in the inner area of the frustum-shaped recess, and further characterized in that the pressure piece and the axial pressure surface, which latter is in the form of a flat pressure surface, are adapted to each other in such a way that the pressure force required for the setting process is transmitted and the tool-side guide surface and the fastening element-side guide region are adapted to each other so as to enable the pressure piece and the flat pressure surface to abut on one another, and the guide region and the guide surface to be brought into contact with one another by an eccentric position of the inserted fastening element.

13. Fastening system according to claim 12 characterized in that in the fastening element the guide region is arranged between the shaft and the flange.

14. Fastening system according to claim 12 characterized in that in the fastening element the flange comprises the guide region.

15. Fastening system according to claim 12 characterized in that in the fastening element the guide region is arranged between the connection region and the flange.

16. Fastening system according to claim 12 characterized in that in the fastening element the guide surface comprises a completely circumferential outer surface of the associated cone.

17. Fastening system according to claim 12 characterized in that in the fastening element the cone forms an angle of more than 35°, in particular of between 35° and 65°, with the axis of the fastening system.

18. Fastening system according to claim 12 characterized in that in the fastening element the flat pressure surface is normal to the shaft axis.

19. Fastening system according to claim 12 characterized in that in the fastening element the connection region is designed such that it defines a contact surface.

20. Fastening system according to claim 19 characterized in that in the fastening element the contact surface is plane-parallel to the axial pressure surface.
